(19) United States
(12) Patent Application Publication
(10) Pub. No.: US 2013/0280133 A1
(43) Pub. Date: Oct. 24, 2013

(54) DEVICE THAT GENERATES OXYGEN AND CONTROLS DELIVERY OF AIR FOR CAR

(71) Applicant: Fu-Lai Han, Tainan (TW)

(72) Inventor: Fu-Lai Han, Tainan (TW)

(21) Appl. No.: 13/451,831

(22) Filed: Apr. 20, 2012

(51) Int. Cl. A62B 11/00

(52) U.S. Cl. 422/107

(57) ABSTRACT

A device that generates oxygen and controls a delivery of air for a car includes a host, a controlling module, a power source, an oxygen sensor, and a remote control. Accordingly, oxygen is delivered into an interior of the car as well as its engine system. Moreover, the device is conveniently portable.

### 1. FIELD OF THE INVENTION

The present invention relates to a device that generates oxygen and controls a delivery of air for a car, especially to the oxygen generator portably disposed in the car for automatically generating oxygen.

### 2. DESCRIPTION OF THE RELATED ART

Normally, cars are driven with the air conditioner turned on, so the windows are usually closed. Herein, the oxygen content in the air is actually poor than the oxygen content outdoors.

A U.S. patent publication No. 20050103341 discloses a “PORTABLE GAS FRACTIONALIZATION SYSTEM” that is movable via a cart. Afore disclosure has shortcomings as follows:

1. The oxygen generator simply generates oxygen. Namely, the oxygen generator can not be automatically turned on or turned off in accordance with the oxygen content in a car.

2. The disclosed oxygen generator does not filter dust, sterilize, or remove harmful substances contained in the generated oxygen. Therefore, the oxygen generated is not clean enough and the air is also not fresh.

3. No pipe arrangement in the car is disclosed. Namely, the generated oxygen and nitrogen can not be individually delivered. Accordingly, the oxygen and the nitrogen are mixed again in the car.

4. The oxygen generator is merely provided for a single individual and has to cooperate with an oxygen mask. Namely, the driver can not use the oxygen generator directly, or multi users can not use the oxygen generator at the same time. Therefore, the disclosure needs improvements.

### SUMMARY OF THE INVENTION

In view of disadvantages existing in the conventional oxygen generator, a device that generates oxygen and controls a delivery of air for a car in accordance with the present invention comprises a host disposed in a first space of the car. The host includes a dust-collecting and sterilization unit connected to at least one air compressor. The air compressor is connected to an exsiccating and discharging unit that is further connected to a low-temperatured catalyst sterilization unit. The low-temperatured catalyst sterilization unit is connected to a molecule sieve that is further connected to a first connector. A controlling module is disposed on the car and connected to the host. The controlling module includes a second connector that is connected to the first connector. The second connector is connected to a flow adjuster that has an output end. The output end is connected to a splitter that includes a first bypass. The first bypass is connected to an oxygen distributor that includes at least one exit. The exit is disposed in a second space of the car. The second space and the first space do not intercommunicate. A power source is fixed to the host and electrically connected to the host. And an oxygen sensor is disposed in the second space of the car. The oxygen sensor is signally connected to the host for sensing oxygen content in the second space, thereby controlling an on-off operation of the host.

Advantages over the present invention are as follows:

1. The present invention creates a space that contains oxygen suited to human body in a car, and multi users benefit at the same time.

2. The present invention collects dust, sterilizes, and removes harmful substances contained in the generated oxygen. Moreover, the generated oxygen is full of Pythoncidere.

3. The present invention automatically senses the oxygen content in the car and provides a feedback mechanism for contributing to a comfortable space with proper oxygen content.

4. The present invention adjusts the oxygen content, and while cooperating with an oxygen mask, the present invention is further offered for emergent medical purpose.

5. When the oxygen is delivered to an engine system of the car, a perfect burning is achievable. Namely, the car discharges cleaner air, which is beneficial to protect environment and decrease the discharge of carbon.

6. When the host is individually drawn out, a cart could be applied for carrying the host to other cars or other places, which allows the host to be independently served as an oxygen generator.

### BRIEF DESCRIPTION OF THE DRAWINGS

FIG. 1 is a schematic view showing components of the present invention;

FIG. 2 is a schematic view showing the present invention installed in a car;

FIG. 3 is a schematic view showing a host of the present invention; and

FIG. 4 is a schematic view showing the host of the present invention being carried by a cart.

### DETAILED DESCRIPTION OF THE PREFERRED EMBODIMENTS

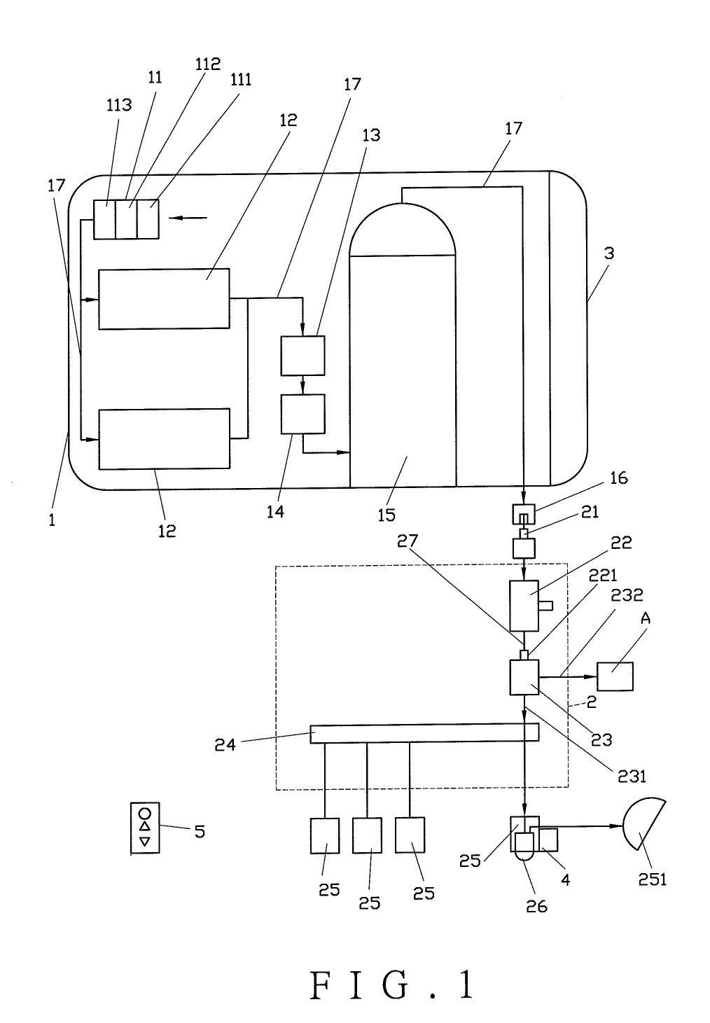

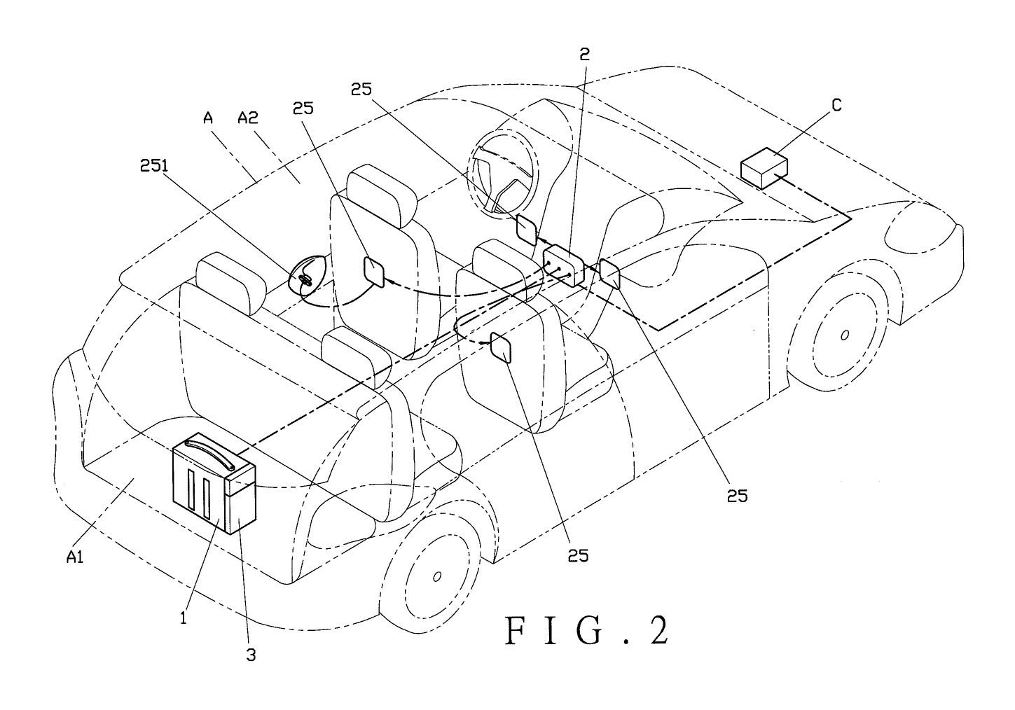

Referring to FIGS. 1 and 2, a device that generates oxygen and controls a delivery of air for a car is installed in a car A and comprises a host 1, a controlling module 2, a power source 3, an oxygen sensor 4, and a remote control 5.

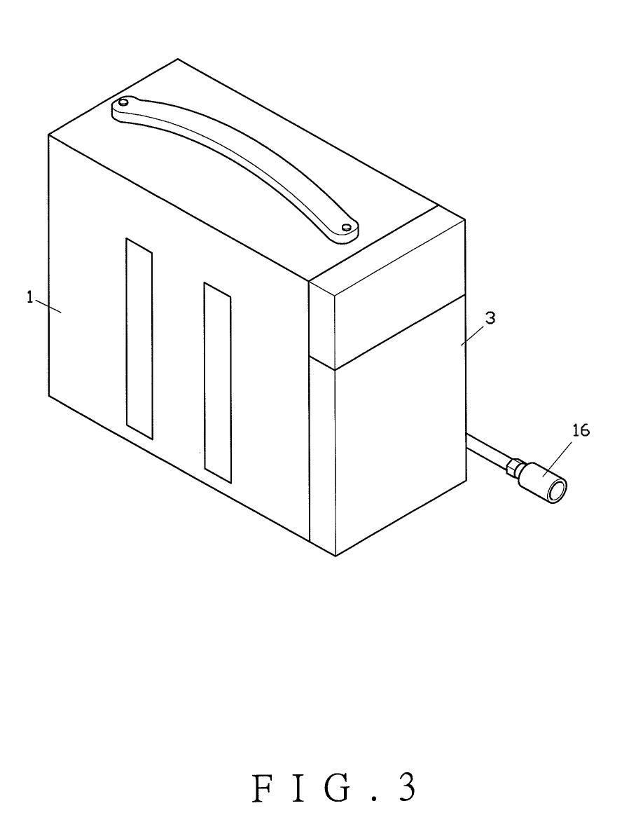

The host 1 is disposed in a first space A1 of the car A. The first space A1 is directed to a trunk. The host 1 includes a dust-collecting and sterilization unit 11 that has a filter net 111, a bamboo charcoal filter 112, and a nano-silver filter 113. The dust-collecting and sterilization unit 11 is connected to at least one air compressor 12. Two sets of the air compressors 12 of 12V direct current are parallelly connected in this preferred embodiment. The air compressors 12 preferably generate compressed air and are connected to an exsiccating and discharging unit 13 that is further connected to a low-temperatured catalyst sterilization unit 14. The lower-temperatured catalyst sterilization unit 14 generates low-temperatured catalyst. The low-temperatured catalyst sterilization unit 14 is connected to a molecule sieve 15 that provides a separation of oxygen over nitrogen. The molecule sieve 15 is further connected to a first connector 16 (as shown in FIG. 3) for providing oxygen. The dust-collecting and sterilization unit 11, the air compressors 12, the exsiccating and discharging unit 13, the low-temperatured catalyst sterilization unit 14, the molecule sieve 15, and the first connector 16, are respectively communicated via a first pipe 17.

The controlling module 2 is connected to the host 1. The controlling module 2 includes a second connector 21 that is connected to the first connector 17 for receiving oxygen. The second connector 21 is connected to a flow adjuster 22 that preferably adjusts the flow of the oxygen. The flow adjuster 22 has an output end 221 for outputting oxygen. The output end 21 is connected to a splitter 23 that includes a first bypass 231 and a second bypass 232. The first bypass 231 is connected to an oxygen distributor 24 that includes at least one exit 25. The exit 25 is disposed in a second space A2 of the car A, and the second space A2 is directed to an interior of the car. The second space A2 and the first space A1 do not intercommunicate. Any one of the exit 25 is connected with an oxygen mask 251 and an oxygen and humidifying bottle 26. The oxygen and humidifying bottle 26 preferably humidifies the oxygen that is dry. Some Phytanicide oil can be properly added in the oxygen and humidifying bottle 26. The second bypass 232 is connected to an engine system C of the car A for increasing the oxygen content in the oil gas for burning. The second connector 21, the flow adjuster 22, the splitter 23, the oxygen distributor 24, and the exit 25 are respectively communicated via a second pipe 27.

The power source 3 is fixed to the host 1 and electrically connected to the host 1. The power source 3 preferably provides electricity to the device for operation. The power source 3 favorably adopts the direct current, namely a storage battery or a battery.

The oxygen sensor 4 is disposed in the second space A2 of the car A for sensing the oxygen content in the car A. The oxygen sensor 4 performs the best when it is installed at the exit 25 of the controlling module 2. The oxygen sensor 4 is signally connected to the host 1 for sensing oxygen content at the exit 25, thereby controlling an on-off operation of the host 1. The oxygen sensor 4 could be powered by an electric system or the storage battery of the car A.

The remote control 5 is provided to be signally connected to the host 1 for controlling an on-off operation of the host 1.

In using, referring to FIGS. 1 and 2, the remote control 5 is applied for manually controlling the operation of the host 1. The host 1 further includes an inlet pipe that guides external air into the car A. The air is inhaled by the dust-collecting and sterilization unit 11 of the host 1 so as to orderly enter the filter net 111, the bamboo charcoal filter 112, and the nano-silver filter 113. Wherein, the filter net 111 sifts the heavy metal and the floating dust in the air, the bamboo charcoal filter 112 separates odor, moisture, and impurities from the air as well as absorb harmful air waves and dust, and the nano-silver filter 113 is antiseptic, deodorant, and anticorrosive. Thereafter, the filtered air enters the air compressors 12 through the first pipe 17. Whereby, the air compressors 12 generate compressed air. The compressed air further enters the exsiccating and discharging unit 13 via the first pipe 17. Herein, a centrifugal force is created along with a speedy rotation, which accordingly removes the moisture contained in the compressed air. Subsequently, the compressed air rises and the moisture drips along the wall. Thence, a discharging valve (not shown) is automatically opened for discharging water. Accordingly, the compressed air enters the low-temperatured catalyst sterilization unit 14 that provides low-temperatured catalyst with catalysis for resulting in a decomposition reaction occurred between the organic compound and the oxygen contained in the compressed air. Consequently, hydrate that is unharmful for human body is caused for cleaning bacteria and carcinogens existing under room temperature. The compressed air further enters the molecule sieve 15 via the first pipe 17, so that the molecule sieve 15 gives the compressed air a separation of oxygen over nitrogen via a pressure swing adsorption. There is an outlet pipe installed on the host 1 for discharging the nitrogen out of the car A. The generated oxygen is output via the first pipe 17 and the first connector 16. The oxygen is thence delivered to the controlling module 2 via the second connector 21 and goes into the flow adjuster 22 via the second pipe 27. The flow adjuster 22 modulates the flow of the oxygen so as to acquire air with different oxygen contents. The present invention is able to modulate the flow of the oxygen from 3 liters per minute to 30 liters per minute. When the oxygen flow is larger, the oxygen content is lower; oppositely, when the oxygen flow is smaller, the oxygen content is higher. The modulated oxygen is discharged via the output end 221 of the flow adjuster 22. When the oxygen enters the splitter 23 via the second pipe 27, the first bypass 231 guides the oxygen into the oxygen distributor 24, so that the oxygen is delivered into the second space A2 of the car A via the exit 25 of the oxygen distributor 24, and the driver as well as passengers can freely breathe the oxygen. When the exit 25 cooperates with the oxygen mask 251, the present invention is suited for emergent medical care. Before passing the exit 25, the oxygen firstly passes the oxygen and humidifying bottle 26 for humidifying the dry oxygen, so that the oxygen is now suited for human body. Herein, the oxygen and humidifying bottle 26 is appropriately added with Phytanicide oil, and thus the provided oxygen contains forest atmosphere. The Phytanicide is able to sterilize and disperse fresh atmosphere. The second bypass 232 is communicated with the engine system C of the car A to increase the oxygen content in the oil gas for burning. The oxygen content and the oxygen flow are decided and regulated in accordance with the design of a cylinder in the engine system C of the car A. Thereby, the burning in the engine system C is more complete, which preferably reduces the discharge of carbon dioxide and promotes a green operation.

During outputting the oxygen, the oxygen sensor 4 responsibly senses the oxygen content in the second space A2. When the oxygen content is saturated, the oxygen sensor 4 allows the host 1 to be automatically turned off and stop generating oxygen. Nonetheless, when the oxygen content is insufficient in the second space A2, the oxygen sensor 4 allows the host 1 to be automatically turned on and start generating oxygen.

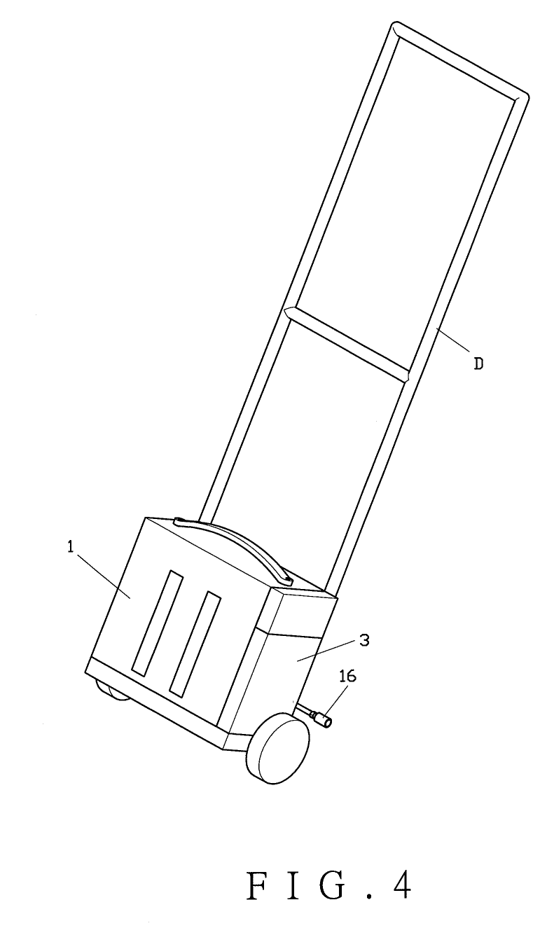

Preferably, if the car A does not need the host 1, the first connector 16 of the host 1 and the second connector 21 of the controlling module 2 are separated so as to individually take out the host 1 from the first space A1 of the car A. Wherein, a cart D (as shown in FIG. 4) preferably carries the host 1 to another car A or other suited positions for operating. When the power source 3 and the remote control 5 are appropriately cooperating with the host 1, an independent oxygen generator is provided.

The host 1 of the present invention could be properly shielded by a cover. Whereby, even if the host 1 and the exit 25 are situated in the same space, partitions are easily caused.

I claim:

1. A device that generates oxygen and controls a delivery of air for a car comprising:
a host disposed in a first space of said car; said host including a dust-collecting and sterilization unit connected to at least one air compressor; said air compressor being connected to an exsiccating and discharging unit that is further connected to a low-temperatured catalyst sterilization unit; said low-temperatured catalyst sterilization unit being connected to a molecule sieve that is further connected to a first connector;
a controlling module disposed on said car and connected to said host; said controlling module including a second connector that is connected to said first connector; said second connector being connected to a flow adjuster that has an output end; said output end being connected to a splitter that includes a first bypass; said first bypass being connected to an oxygen distributor that includes at least one exit; said exit being disposed in a second space of said car; said second space and said first space do not intercommunicate;
a power source fixed to said host and electrically connected to said host; and
an oxygen sensor disposed in said second space of said car; said oxygen sensor being signally connected to said host for sensing oxygen content in said second space, thereby controlling an on-off operation of said host.

2. The device as claimed in claim 1, wherein, a remote control is provided to be signally connected to said host for controlling an on-off operation of said host.

3. The device as claimed in claim 1, wherein, said dust-collecting and sterilization unit, said air compressor, said exsiccating and discharging unit, said low-temperatured catalyst sterilization unit, said molecule sieve and said first connector are respectively communicated via a first pipe.

4. The device as claimed in claim 1, wherein, said exit is connected to an oxygen mask.

5. The device as claimed in claim 1, wherein, said exit is connected to an oxygen and humidifying bottle.

6. The device as claimed in claim 1, wherein, said second connector, said flow adjuster, said splitter, said oxygen distributor, and said exit are respectively communicated via a second pipe.

7. The device as claimed in claim 1, wherein, said dust-collecting and sterilization unit includes a filter net, a bamboo charcoal filter, and a nano-silver filter.

8. The device as claimed in claim 1, wherein, said car includes an engine system, and said splitter has a second bypass that is connected to said engine system.

9. The device as claimed in claim 1, wherein, said first space is a trunk.

10. The device as claimed in claim 1, wherein, said second space is an interior of said car.
